(19) United States
(12) Patent Application Publication
(10) Pub. No.: US 2008/0010643 A1
(43) Pub. Date: Jan. 10, 2008

(54) Multiprocessor system and access right setting method in the multiprocessor system

(75) Inventors: Yoshihiro Oohira, Kanagawa (JP); Hitoshi Suzuki, Kanagawa (JP); Masayuki Daito, Kanagawa (JP)

Correspondence Address: FOLEY AND LARDNER LLP;SUITE 500, 3000 K STREET NW, WASHINGTON, DC, 20007, US

(73) Assignee: NEC ELECTRONICS CORPORATION

(21) Appl. No.: 11/822,335

(22) Filed: Jul. 5, 2007

(30) Foreign Application Priority Data
Jul. 7, 2006 (JP) 188364/2006
May 18, 2007 (JP) 132461/2007

(51) Int. Cl. G06F 9/46

(52) U.S. Cl. 718/102

(57) ABSTRACT

An access of a processor having an access right to a shared resource is affected by the polling operation of a processor having no access right. A multiprocessor system having a plurality of processors, and a shared resource that can be accessed by the plural processors, the multiprocessor system includes a shared bus that connects the plural processors to the shared resource, a mutual exclusion control unit that holds identification information indicating which processor has an access right to the shared resource among the plural processors, and a local bus that connects the mutual exclusion control unit and the plural processors.

### BACKGROUND OF THE INVENTION

1. Field of the Invention

The present invention relates to a multiprocessor system and more particularly to an access right setting method to a shared resource in a multiprocessor system.

2. Description of Related Art

In recent years, multiprocessor systems having plural CPUs have been spread. There is a case in which plural CPU cores share, for example, a memory and other peripheral circuits in the above multiprocessor system. Portions that are shared by the plural CPU cores are called “shared resource”. In the case of using the shared resource, a CPU that acquires the use rights of the shared resource is required so as not to compete against the access to the shared resource from another CPU.

JP-A No. 4(1992)-343143 discloses a technique of a mutual exclusion system in the multiprocessor system of the above type. FIG. 13 is a diagram for explaining the general mutual exclusion system. In FIG. 13, plural CPUs 101 to 10n are connected to a shared resource 300 through a shared bus 200. The shared resource 300 holds a value that is called “mutual exclusion variable 301” in a register within the shared resource 300. The mutual exclusion variable 301 is a flag for indicating whether the shared resource 300 is now accessed by any CPU, or not. A description will be given of the conventional mutual exclusion system in the case where “0” is a variable that can access to the shared resource 300, and “1” is a variable that cannot access to the shared resource 300 in the mutual exclusion variable 301 as one example.

In the case where the CPU 101 in FIG. 13 accesses to the shared resource 300, the CPU 101 reads the mutual exclusion variable. 301 from the shared resource 300. As a result, when the mutual exclusion variable 301 is “0”, because an access to the shared resource is enabled, the CPU 101 rewrites the mutual exclusion variable 301 to “1”, and starts the access to the shared resource 300.

In this state, in the case where the CPU 102 is going to access to the shared resource 300, because the mutual exclusion variable 301 that is read by the CPU 102 is “1”, the CPU 102 cannot acquire the access right. The CPU 102 again attempts to access to the shared resource 300 after a given period of time has been elapsed. In the case where the CPU 101 has completed the access to the shared resource 300, the CPU 101 rewrites the mutual exclusion variable to “0” to complete the access.

At this moment, in the case where the CPU 102 again attempts to access to the shared resource 300, because the mutual exclusion variable 301 that is read by the CPU 102 is “0”, the CPU 102 acquires the access right to the shared resource 300. Up to now, the CPU uses the mutual exclusion variable 301 as described above, to conduct the mutual exclusion with respect to the shared resource.

However, in the case where the CPU 102 conducts the above mutual exclusion, the CPU that could not acquire the access right continuously attempts to acquire the access right to the shared resource 300. As a result, a request for the access right to the shared resource 300 is repeatedly conducted through the shared bus 200, and the access per se of the CPU that has got the access right to the shared resource 300 is prevented.

Also, there is a case in which, for example, when the CPU 101 acquires the access right to the shared resource 300, and implements certain processing, the shared resource 300 is used for another processing necessary to implement the certain processing. In this case, the CPU 101 again unintentionally reads the mutual exclusion variable 301 when a request for accessing to the shared resource 300 is included during another processing. In this situation, the CPU 101 unintentionally reads the mutual exclusion variable “1” that has been rewritten by the CPU 101 per se, and comes to a dead lock state where the access right cannot be permanently gotten.

For that reason, Up to now, the following mutual exclusion control is also conducted. The values that are set as the mutual exclusion variable 301 are set to not only “0” and “1”, but also values unique to the respective CPUs. For example, the mutual exclusion variable 301 in a state where the shared resource 300 is available is held as “0”, the mutual exclusion variable 301 in a state where the CPU 101 accesses to the shared resource 300 is held as “1”, and the mutual exclusion variable 301 in a state where the CPU 102 accesses to the shared resource 300 is held as “2”. Then, in the case where the CPU requests an access to the shared resource, the respective CPUs first read the mutual exclusion variable 301, and determines whether the shared resource 300 is available, or not, that is, whether the mutual exclusion variable 301 is “0”, or not. In the case where the mutual exclusion variable 301 is not“0”, the CPU then compares the read mutual exclusion variable 301 with the value unique to the CPU per se. As a result, in the case where the mutual exclusion variable 301 coincides with the value unique to the CPU per se, the CPU overwrites the value unique to the CPU on the mutual exclusion variable 301 to again acquire the access right. The CPU thus conducts the mutual exclusion control to avoid the above dead lock state.

We have now discovered that the CPU that could not acquire the access right even if the CPU conducts the above mutual exclusion control continuously attempts to acquire the access right to the shared resource, to thereby prevent an access of the CPU that has got the access right to the shared resource on the shared bus.

Also, in the case where the mutual exclusion variable is set as the unique value of the CPU, the respective CPUs are required to conduct the operation of comparing the unique value of the CPU per se with the read mutual exclusion variable, and the operation of writing the value unique to the CPU into the mutual exclusion variable. This increases the number of execution commands of the respective CPUs, and induces the insufficiency of the entire multiprocessor system.

### SUMMARY

According to one aspect of the present invention, a multiprocessor system, having plural processors, and a shared resource that can be accessed by the plural processors, the multiprocessor system, includes: a shared bus that connects the plural processors to the shared resource; a mutual exclusion control unit that holds identification information indicating which processor acquires an access right to the shared resource among the plural processors; and a local bus that connects the mutual exclusion control unit and the plural processors.

With the above configuration, the mutual exclusion control is conducted through the local bus without affecting an access of the processor having the access right to the shared resource to the shared resource through the shared bus.

Also, according to another aspect of the present invention, an access right setting method sets an access right to one of the plural processors with respect to the shared resource that is shared by the plural processors, and the method includes: holding information of a processor having the access right to the shared resource among the plural processors; determining a processor that requests the access right to the shared resource; comparing the determination result with the information of the processor having the access right; and outputting the presence or absence of the access right of the processor that requests the access right to the shared resource.

Since the access right is set as described above, the processor side that requests the access right merely determines the presence or absence of the access right, that is, the acquisition of the access right is successful or unsuccessful, thereby enabling the number of command executions to be reduced.

It is possible to suppress an influence of the polling operation of the CPU having no access right on the shared bus.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram showing a multiprocessor system according to a first embodiment of the present invention;

FIG. 2 is a diagram showing a mutual exclusion control unit according to the first embodiment;

FIG. 3 is a diagram showing a multiprocessor system according to the first embodiment of the present invention;

FIG. 4 is a flowchart according to the first embodiment;

FIG. 5 is a diagram showing a mutual exclusion control unit according to a second embodiment of the present invention;

FIG. 6 is a flowchart showing a mutual exclusion control unit according to the second embodiment;

FIG. 7 is a diagram showing a state transition of the mutual exclusion control unit according to the second embodiment;

FIG. 8 is a flowchart showing CPU operations according to the second embodiment;

FIG. 9 is a diagram showing a mutual exclusion control unit according to a third embodiment of the present invention;

FIG. 10 is a diagram showing a multiprocessor system according to a fourth embodiment of the present invention;

FIG. 11 is a diagram showing a mutual exclusion control unit according to a fifth embodiment of the present invention;

FIG. 12 is a diagram showing a mutual exclusion control unit according to a sixth embodiment of the present invention; and

FIG. 13 is a diagram showing a multiprocessor system in the conventional art.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes. In the following embodiments, a multiprocessor system having two CPUs is used as an example of the multiprocessor system according to the present invention. However, the present invention is applicable to a CPU having three or more CPUs. Also, the multiprocessor system can be constituted on a one-chip semiconductor, or can be constituted in such a manner that the respective CPUs are independent chips, and connected through an external bus.

### First Embodiment

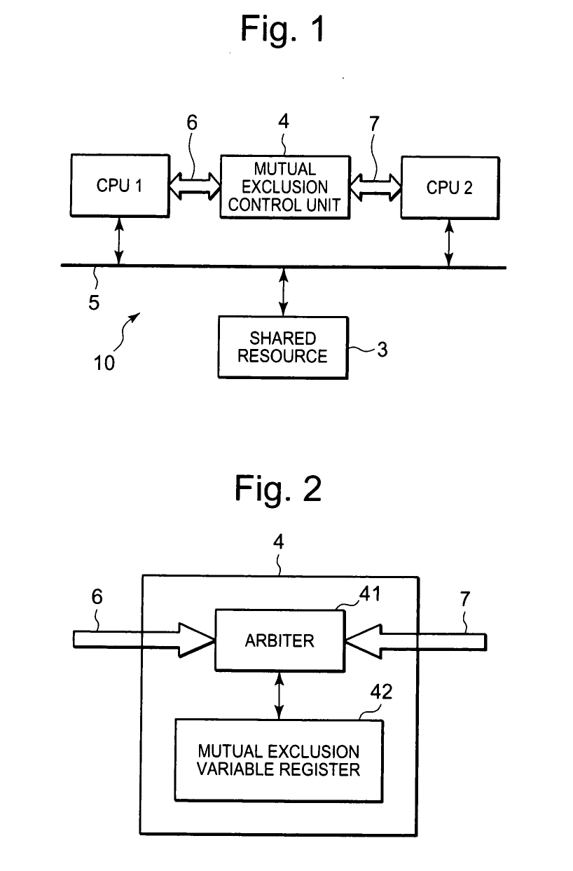

FIG. 1 is a block diagram showing a multiprocessor system 10 according to a first embodiment of the present invention. As shown in FIG. 1, the multiprocessor system 10 according to this embodiment includes a first CPU (hereinafter referred to as “CPU1”), a second CPU (hereinafter referred to as “CPU2”), a shared resource 3 that is a peripheral circuit, a mutual exclusion control unit 4, a shared bus 5, and local buses 6, 7.

The CPU 1 and the CPU 2 access to the shared resource 3 through the shared bus 5, and executes various processing on the basis of program. The mutual exclusion control unit 4 is connected to the CPU 1 and the CPU 2 to the local buses 6 and 7, respectively, and controls the access right of the CPUs to the shared resource 3. The configuration of the mutual exclusion control unit 4 in this embodiment is shown in FIG. 2. As shown in FIG. 2, the mutual exclusion control unit 4 according to the first embodiment has an arbiter 41 and a mutual exclusion variable register 42.

The arbiter 41 is a circuit that arbitrates a connection between the mutual exclusion variable register 42 and the CPUs in the case where plural CPUs access to the mutual exclusion control unit 4 at the same time. Accordingly, the arbiter 41 is connected with the local buses 6, 7 and the mutual exclusion variable register 42. The mutual exclusion variable register 42 is a register having an address allocated thereto which is accessed from the CPU 1 and the CPU 2 by designation of the address. The mutual exclusion variable register 42 holds the mutual exclusion variable that is read or written by the CPU 1 and the CPU 2.

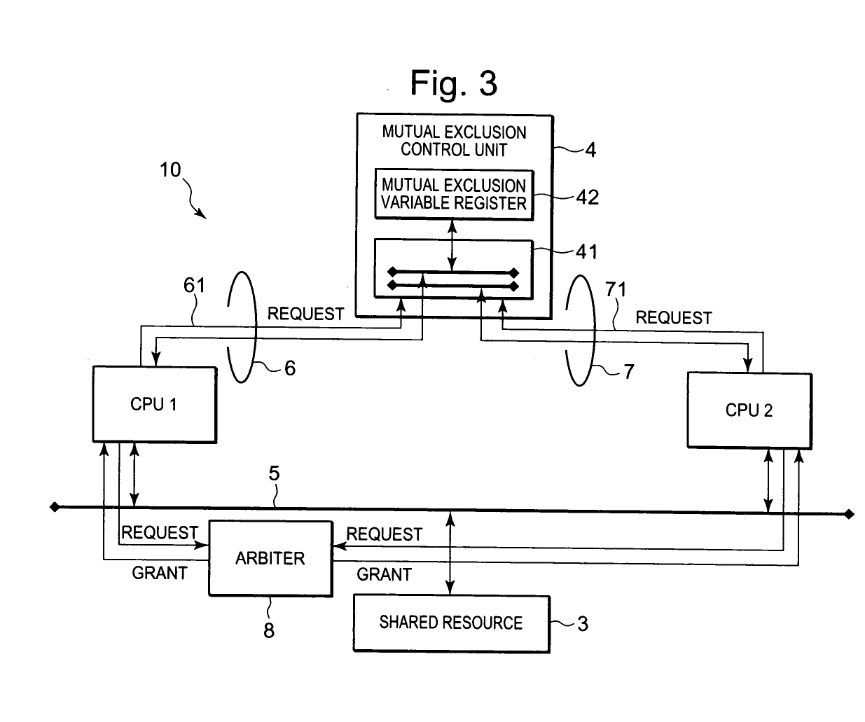

FIG. 3 is a diagram showing the multiprocessor system shown in FIG. 1 in more detail. As shown in FIG. 3, the multiprocessor system according to this embodiment further includes an arbiter 8 that arbitrates the use rights of the shared bus 5.

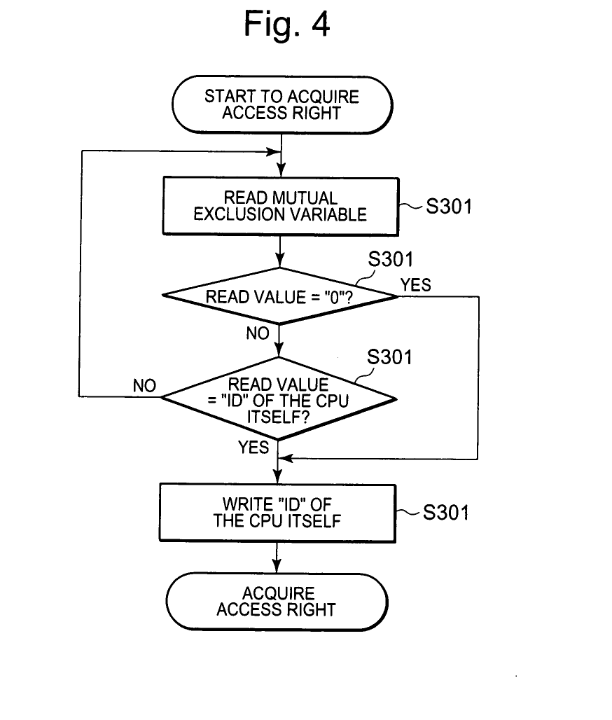

The operation of the mutual exclusion control thus configured according to this embodiment will be described below. In the following description, the mutual exclusion variable is set as “0” in the case where the access right to the shared resource 3 is available, that is, in the case where none of the CPUs acquires the access right to the shared resource. FIG. 4 shows a flowchart corresponding to the operation of acquiring the access right by means of the CPU 1 or the CPU 2.

A description will be given of a case in which the CPU 1 requests the access right of the shared resource 3 in a state where the mutual exclusion variable register 42 holds “0”. In the case where the CPU 1 requests the access right of the shared resource 3, the CPU 1 outputs a read request to the mutual exclusion control unit 4 through the local bus 6 (refer to a line 61 in FIG. 3 and S301 in FIG. 4). The read request is supplied to the mutual exclusion control unit 4 through the local bus 6. The mutual exclusion control unit 4 reads a value that is held by the mutual exclusion variable register 42, and outputs the read value to the CPU 1. When the mutual exclusion variable register 42 holds “0”, the mutual exclusion control unit 4 outputs “0” to the CPU 1.

The CPU 1 determines whether the read value is “0”, or not, and when the read value is “0”, the CPU 1 conducts a write request with respect to the mutual exclusion control unit 4 (refer to S302 in FIG. 4). In this situation, the value when the CPU 1 conducts the write request is a value unique to the CPU 1 (in this example, “ID1”). The mutual exclusion control unit 4 writes “ID1” in the mutual exclusion variable register 42 according to the write request from the CPU 1 (refer to S304 in FIG. 4), and the CPU 1 acquires the access right. The CPU 1 that has acquired the access right by means of the mutual exclusion control unit 4 shown in FIG. 1 requests the use of the shared bus 5 with respect to the arbiter 8. In the case where the use of the shared bus 5 is allowed by the arbiter 8, the CPU 1 accesses to the shared resource 3 through the shared bus 5, and executes necessary processing.

A description will be given of a case in which the CPU 2 requests the access right with respect to the shared resource 3 in a state where the CPU 1 acquires the access right. In the case where the CPU 2 requests the access right to the shared resource 3, the CPU 2 outputs the read request to the mutual exclusion control unit 4 as in a case where the CPU 1 requests the access right (refer to S301 in FIG. 4). The read request is given to the mutual exclusion control unit 4 through the local bus 71. The mutual exclusion control unit 4 reads the value “ID1” that is held by the mutual exclusion variable register 42, and outputs the read value “ID1” to the CPU 2.

The CPU 2 determines whether the read value is “0”, or not (refer to S302 in FIG. 4). In this example, since the read value is not “0”, the CPU 2 does not output the write request, and shifts to the subsequent determining operation. Because the read value is not “0”, the CPU 2 determines whether the read value is identical with the value unique to the CPU 2 (“ID2” in this example), or not (refer to S303 in FIG. 4). In this case, because the read value is “ID1” which is different from “ID2” of the CPU 2, the CPU 2 conducts the polling operation such that the CPU 2 again conducts the read request after a given period of time.

Also, there is a case in which after the CPU has acquired the access right of the shared source 3 during execution of a certain process (called “process A” in this example) once, the CPU conducts another processing (called “process B” in this example) before the completion of the process A, and the process B acquires the access right of the shared resource 3, depending on program that is executed by the CPU. Then, it is necessary that the CPU again returns to the execution of the process A, and completes the process A after the completion of the process B. In view of this case, a description will be given of a case in which the CPU 1 requests the access right of the shared resource 3 during execution of the process B in a state where the CPU 1 has acquired the access right of the shared resource 3 during execution of the process A. As in the above case, the CPU 1 outputs the read request to the mutual exclusion control unit 4 (refer to S301 in FIG. 4). The read request is given to the mutual exclusion control unit 4 through the local bus 6. The mutual exclusion control unit 4 reads the value “ID1” that is held by the mutual exclusion variable register 42, and outputs the read value “ID1” to the CPU 1.

The CPU 1 determines whether the read value is “0”, or not (refer to S302 in FIG. 4), and since the read value is not “0” in this example, the CPU 1 shifts to the subsequent determining operation. The CPU 1 determines whether the read value is identical with “ID1” of the CPU 1, not (refer to S303 in FIG. 4). In this case, the read value is “ID1” which is the same value as “ID1” of the CPU 1. Accordingly, the CPU 1 conducts the write request of “ID1” to the mutual exclusion control unit 4, and the mutual exclusion control unit 4 writes “ID1” in the mutual exclusion variable register 42 (refer to S304 in FIG. 4). The CPU 1 acquires the access right to the shared resource 3, and requests the use of the shared bus to the arbiter 8. In the case where the user of the shared bus is allowed by the arbiter 8, the CPU 1 continues the access to the shared resource 3 through the shared bus 5.

As described above, according to the first embodiment, the local buses 6 and 7 which are different from the shared bus 5 are used to connect the respective CPUs and the mutual exclusion control unit 4, and reads a state in which the shared resource 3 is available, or the unique value (ID) of the CPU having the access right to the shared resource 3 from the mutual exclusion control register 42 within the mutual exclusion control unit 4. For that reason, the access request that is conducted by the polling operation of the CPU having no access right to the shared resource 3 is not conducted through the shared bus 5. Accordingly, the shared bus 5 is not affected by the polling operation, and the CPU having the access right to the shared resource 3 is capable of executing the process rapidly.

### Second Embodiment

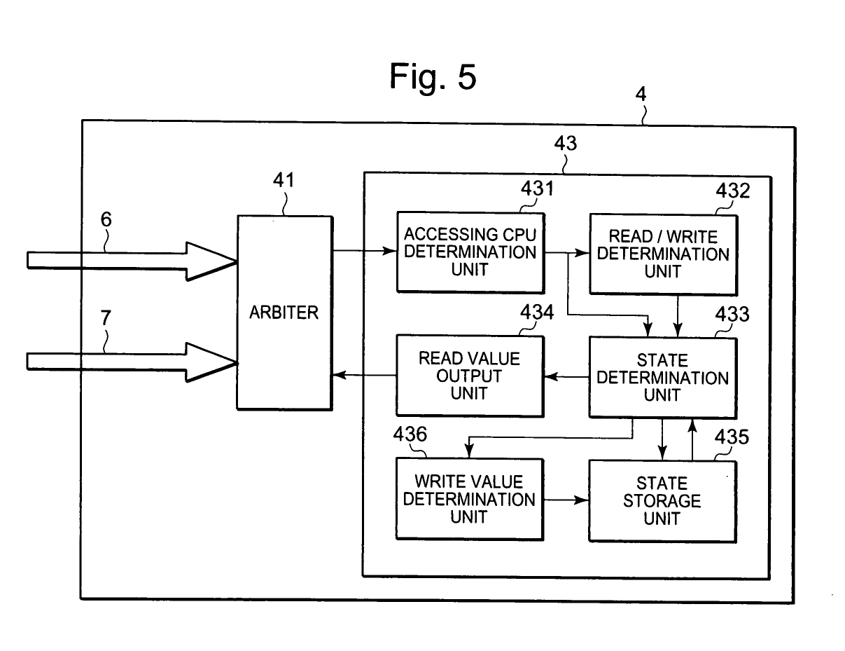

FIG. 5 is a block diagram showing the configuration of the mutual exclusion control unit 4 according to a second embodiment of the present invention. The configuration of the multiprocessor system 10 is identical with that shown in FIG. 1, and therefore its detailed description will be omitted. The mutual exclusion control unit 4 according to the second embodiment includes an arbiter 41 and a shared resource access control unit 43. The shared resource access control unit 43 includes an accessing CPU determination unit 431, a read/write determination unit 432, a state determination unit 433, a read value output unit 434, a state storage unit 435, and a write value determination unit 436.

The arbiter 41 is a circuit arbitrates the plural CPUs and the shared resource access control unit 43. The shared resource access control unit 43 has an address allocated thereto, and is accessed from the CPU 1 and the CPU 2 by designation of the address. The shared resource access control unit 43 controls the CPU that accesses to the shared resource 3, and conducts the mutual exclusion. The accessing CPU determination unit 431 determines the accessing CPU on the basis of a signal that is supplied through the arbiter 41, and then specifies the accessing CPU. The read/write determination unit 432 determines whether the supplied signal is a read signal, or a write signal, and outputs the determination result. The state determination unit 433 reads the present state from the state storage unit 435, or outputs a signal for writing information on the present state in the state storage unit 435 to the write value determination unit 436, on the basis of the output of the read/write determination unit 432. The state storage unit 435 holds the information on the CPU presently having the access right to the shared resource 3. The write value determination unit 436 determines the write value for the state storage unit 435 on the basis of the output of the state determination unit 433, and determines information that is written in the state storage unit 435. The more detailed description of the above-described respective units will be made while the operation is exemplified in the following description.

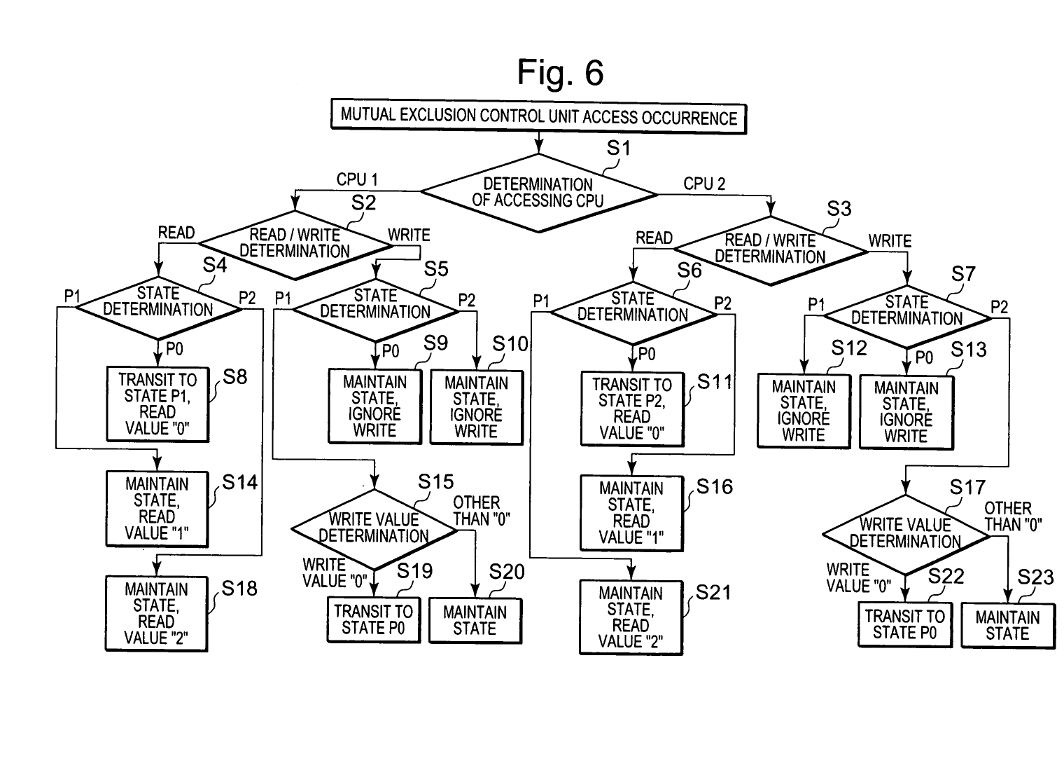

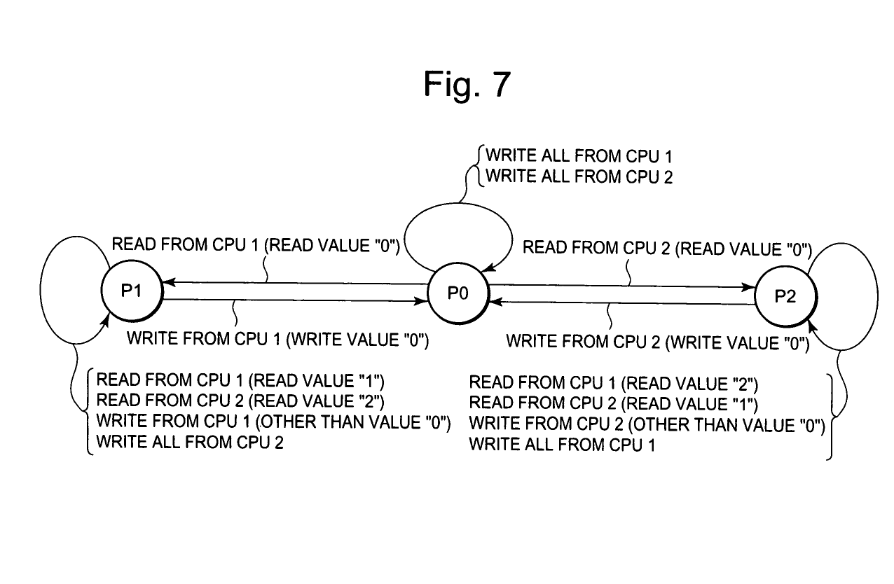

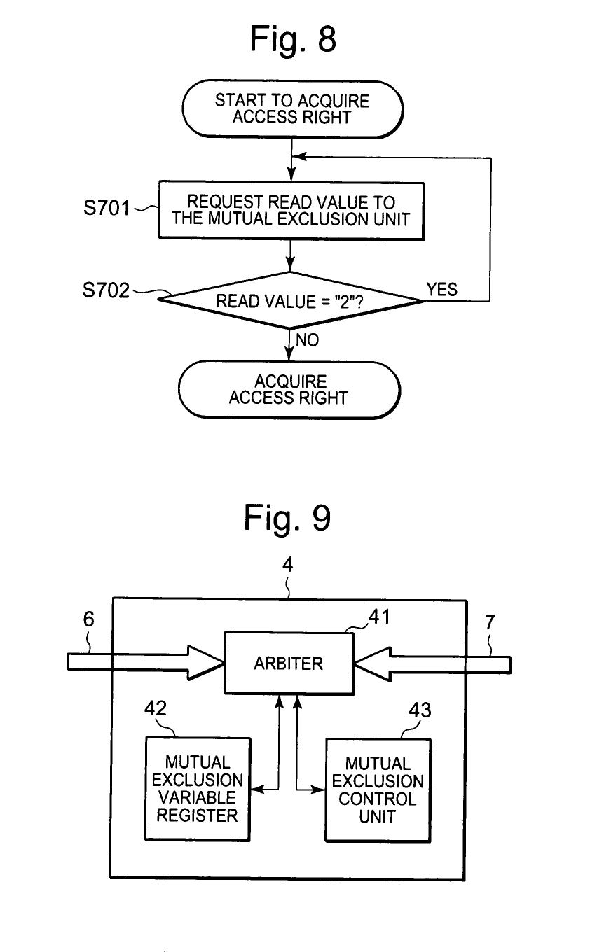

FIG. 6 is a flowchart showing the operation of the mutual exclusion control unit 4 according to this embodiment. Also, FIG. 7 is a state transition diagram showing a state attributable to the operation of the mutual exclusion control unit 4. FIG. 8 is a flowchart showing an access right request that is executed by the CPU 1 or the CPU 2. Hereinafter, a description will be given of the operation of this embodiment with reference to FIGS. 5 to 8. In the following operation, an example in which the CPU 1 and CPU 2 request the access right to the shared resource 3 through the local buses 6 and 7 will be described with reference to FIG. 1.

First, a description will be given of an example in which none of the CPUs holds the access right to the shared resource 3, and the CPU 1 requests the access right to the shared resource in the state where the shared resource is available. The CPU 1 requests the access right to the shared resource 3, and therefore conducts the read request to the mutual exclusion control unit 4 through the local bus 6 (refer to S701 in FIG. 8). The read request is given to the accessing CPU determination unit 431 of the shared resource access control unit 43 through the arbiter 41.

The accessing CPU determination unit 431 determines which CPU conducts the read request (refer to S1 of FIG. 6). The accessing CPU is capable of immediately conducting the determination because the determination can be conducted by merely determining which local bus the access is made through, in the case of the multiprocessor system in which the local buses are arranged as shown in FIG. 1. In this example, the accessing CPU determination unit 431 determines that the access is made by the CPU 1, and outputs the information to the state determination unit 433. Also, the read/write determination unit 432 determines whether the read request from the CPU 1 is the read request or the write request (refer to S2 in FIG. 6). In this example, because of the read request, the read/write determination unit 432 outputs information indicative of the read request to the state determination unit

The state determination unit 433 confirms the present state of the shared resource 3 which is stored in the state storage unit 435 (refer to S4 in FIG. 6).

The above-mentioned state storage unit 435 is a portion that holds the information related to the CPU having the present access right with respect to the shared resource 3. In the case where the CPU1 and the CPU2 exist, there are the following three states of the access right to the shared resource 3.

State P0: a state in which the shared resource 3 is available;

State P1: a state in which the access right to the shared resource 3 is acquired by the CPU 1; and

State P2: a state in which the access right to the shared resource 3 is acquired by the CPU 2.

In this example, since the shared resource 3 is available, the state storage unit 435 holds the state P0. In this example, because the shared resource 3 is now in the available state P0, and the read request is made by the CPU 1, the state determination unit 433 transits the state in which the state storage unit 435 is stored to the state P1 in which the CPU 1 acquires the access right (refer to S8 of FIG. 6 and FIG. 7). Thereafter, the state determination unit 433 designates the lead value that is output to the CPU 1 with respect to the lead value output unit 434.

The read value output unit 434 outputs the read value that is designated by the state determination unit 433 to the CPU 1. In this example, there exist the following three read values that are output by the read value output unit 434 according to the state that is stored in the state storage unit 435 and the operation that is conducted by the state determination unit 433.

Read value “0”: a read value indicating that the access right is newly acquired;

Read value “1”: a read value indicating that the access right has been already acquired; and

Read value “2”: a read value indicating that the access right has been already acquired by another CPU.

In this example, because the CPU 1 newly acquires the access right from the state P0 in which the shared resource 3 is available, and transits to the state P1, the read value output unit 434 outputs the read value “0” corresponding to a case where the access right is newly acquired (refer to S8 in FIG. 6 and FIG. 7).

The CPU 1 determines whether the read value is the read value “2”, or not (refer to S702 of FIG. 8). As described above, because the read value “2” is the state in which another CPU acquires the shared resource 3, when the read value is “2”, the CPU 1 conducts the polling operation. In this example, the read value is “0”. For that reason, the CPU 1 determines that the CPU 1 per se had acquired the access right, and requests the use of the shared bus to the arbiter 8. In the case where the use of the shared bus is allowed by the arbiter 8, the CPU 1 starts the access to the shared resource 3.

Subsequently, a description will be given of an example in which the CPU 2 requests the access right to the shared resource in a state where the CPU 1 acquires the access right. The CPU 2 conducts the read request to the mutual exclusion control unit 4 similarly when the CPU 1 requests the access right (refer to S701 in FIG. 8). The CPU 2 gives the read request to the accessing CPU determination unit 431 of the shared resource access control unit 43 through the local bus 7 and the arbiter 41, and determines which CPU the request is made from (refer to S1 in FIG. 6). Also, the read/write determination unit 432 determines whether the request is the read request or the write request (refer to S3 of FIG. 6).

The state determination unit 433 confirms the present state of the shared resource 3 that exists in the state storage unit 435 on the basis of the read request from the CPU 2 (refer to S6 in FIG. 6). In this example, the state storage unit 435 holds the above state P1. Because the accessing CPU 2 is different from the CPU now having the access right to the shared resource, the state determination unit 433 designates the read value “2” to be output to the read value output unit 434 without changing the state P1 that is hold by the state storage unit 435 (refer to S21 in FIG. 6 and FIG. 7).

The read value output unit 434 outputs the read value “2”, and the CPU 2 determines the input read value. Because the read value is “2”, the CPU 2 determines that the CPU other than the CPU 2 has the access right to the shared resource, and conducts the polling operation (refer to S702 in FIG. 8).

Subsequently, a description will be given of a case in which the CPU 1 conducts the process B during execution of the process A, and thereafter returns to the process A in the state where the CPU 1 has acquired the access right as described in the first embodiment. For example, in the case where the CPU 1 shifts from the process A to the process B, the CPU 1 outputs the read request to the mutual exclusion control unit 4 in the process B. The CPU 1 gives the read request to the mutual exclusion control unit 4 through the local bus 6. The shared resource access control unit 43 determines the accessing CPU and the read/write request (refer to S1 and S2 in FIG. 6).

The state determination unit 433 confirms the present state of the shared resource 3 which is stored in the state storage unit 435 on the basis of the read request from the CPU 1. In this example, the state storage unit 435 holds the above state P1. Because the accessing CPU 1 is identical with the CPU now having the access right to the shared resource, the state determination unit 433 designates the read value “1” to be output to the read value output unit 434 without changing the state P1 that is hold by the state storage unit 435 (refer to S14 in FIG. 6 and FIG. 7).

The CPU 1 determines whether the read value is “2”, or not, and in this example, since the read value is not “2”, the CPU 1 determines that the access right to the shared resource 3 has been acquired. In the case where the use of the shared bus is permitted by the arbiter 8, the CPU 1 continues the access to the shared resource 3 through the shared bus 5 (refer to S702 in FIG. 8).

Subsequently, a description will be given of a case in which the CPU 1 releases the access right to the shared resource 3 in the state where the CPU 1 has acquired the access right. The CPU 1 outputs the write request together with the write value to the mutual exclusion control unit 4. In this example, there are the following two write values that are output to the mutual exclusion control unit 4 by the CPU.

Write value “0”: a write value that releases the access right; and

Write value “1”: a write value that continues the access right.

Write values other than the above write values are invalid as the write value, and therefore are ignored in the mutual exclusion control unit 4 even if those values are output as the write value.

In this example, because the CPU 1 releases the shared resource 3, the CPU 1 outputs the write request with the write value “0”. The CPU 1 supplies the write request to the mutual exclusion control unit 4 through the local bus 6. The shared resource access control unit 43 determines the accessing CPU and the read/write request (refer to S1 and S2 in FIG. 6).

The state determination unit 433 confirms the present state of the shared resource 3 which is stored in the state storage unit 435 (refer to S5 in FIG. 6). In this example, if the state storage unit 435 holds the above state P1. Because the accessing CPU 1 is identical with the CPU now having the access right to the shared resource, the write value determination unit 436 determines the write value (refer to S15 in FIG. 6). In this example, the CPU that has output the write request is different from the CPU 1 that has now acquired the access right (for example, in the case of the CPU 2), the write request is in error and therefore ignored (refer to S12 in FIG. 6). The write value determination unit 436 determines whether the write value that has been input together with the write request is the write value “0” or the write value “1”. In this example, because the CPU 1 releases the shared resource, the write value is “0”. For that reason, the write value determination unit 436 changes the state P1 that is held by the state storage unit 435 to the state P0 in which the shared resource is released, and completes the processing (refer to S19 in FIG. 6).

In the operation of the above example, for example, in the operation of shifting from the process A to the process B, and thereafter returning to the process A, it is possible to output the write request of the write value “1” from the CPU 1 at the time of returning from the process B to the process A. In this case, the write value determination unit 436 determines that the write value is “1” as with the operation of releasing the shared resource 3. In this case, since the write value is “1”, the CPU 1 continues the access right to the shared resource 3 without changing the state (refer to S20 in FIG. 6 and FIG. 7).

The above description is mainly given of the case in which the CPU 1 has the access right to the shared resource. Similarly, the same operation is basically conducted in the case where the CPU 2 has the access right to the shared resource as shown in FIGS. 6 to 8. Hereinafter, a description will be given of the operation of the read request and the operation of the write request in the multiprocessor system having the CPU 1 and the CPU 2 in Table 1 and Table 2:

TABLE 1
Operation of the shared resource access control unit 43 due to
read request

| Operation at read time from CPU 1 | Operation at read time from CPU 2 |
|---|---|
| In case of P0 state, the state | In case of P0 state, the state |
| is transited to P1 state, and | is transited to P2 state, and |
| the read value “0” is returned | the read value “0” is returned |
| In case of P1 state, the read | In case of P1 state, the read |
| value “1” is returned without | value “2” is returned without |
| changing state | changing state |
| In case of P2 state, the read | In case of P2 state, the read |
| value “2” is returned without | value “1” is returned without |
| changing state | changing state |

TABLE 2
Operation of the shared resource access control unit 43 due to
write request

| Operation at write time from | |
|---|---|
| CPU 1 | Operation at write time from CPU 2 |
| Incase of P0 state, ignore write | Incase of P0 state, ignore write |
| access | access |
| In case of P1 state, | Incase of P1 state, ignore write |
| “0” is written, and transit to | access |
| P0 state | In case of P2 state, |
| “1” is written and maintain P1 | “0” is written, and transit to |
| state | P0 state |
| write access of another value | “1” is written and maintain P2 |
| is ignored | state |
| In case of P2 state, ignore write | write access of another value |
| access | is ignored |

As in the first embodiment, this embodiment is designed in such a manner that the respective CPUs and the mutual exclusion control unit 4 are connected to each other through the local buses 6 and 7 which are different from the shared bus 5, and the available state of the shared resource 3 is read from the shared resource access control unit 43 within the mutual exclusion control unit 4. For that reason, the shared bus 5 is not affected by the polling operation, and the CPU having the shared resource 3 and the access right is capable of executing the processing rapidly.

In addition, the mutual exclusion control unit 4 according to this embodiment determines the CPU now having the access right to the shared resource by the aid of the state determination unit 433 and the state storage unit 435. Accordingly, it is possible to reduce the overhead attributable to an increase in the number of command executions at the CPU side. In this embodiment, the shared resource access control unit 43 outputs a state in which the shared resource 3 is available, a state in which another CPU has the access right, or a state in which the CPU per se that requests the access right has the access right. For that reason, the CPU side is capable of determining the presence or absence of the access right by only determining whether another CPU uses the access right, or not, as shown in FIG. 8, thereby enabling the overhead of the number of command executions to be reduced. Also, in this embodiment, there is no necessity that the plural CPUs have the unique values, respectively, and even if the CPUs have the unique values, respectively, because the self CPU is merely shown at the time of the read request or the write request, it is possible to delete the overhead of the command execution.

### Third Embodiment

FIG. 9 is a block diagram showing the configuration of the mutual exclusion control unit 4 according to a third embodiment of the present invention. The configuration of the multiprocessor system 10 is identical with that shown in FIG. 1, and therefore its detailed description will be omitted. This embodiment includes an arbiter 41, a mutual exclusion variable register 42, and a shared resource access control unit 43. The arbiter 41 arbitrates an access of the mutual exclusion variable register 42, the shared resource access control unit 43, and the CPU. The mutual exclusion variable register 42 is a mutual exclusion variable register 42 configured as in the first embodiment. The mutual exclusion variable register 42 holds the available state of the shared resource 3, or the unique value of each of the CPUs that acquire the access right to the shared resource 3. The shared resource access control unit 43 is a shared resource access control unit 43 as in the second embodiment. The shared resource access control unit 43 outputs a state in which the shared resource 3 is variable, a state in which another CPU accesses to the shared resource, or a state in which the CPU per se that requests the access accesses to the shared resource.

With the above configuration, it is possible to appropriately set the access right of the shared resource 3 even in the multiprocessor system in which the CPU having the unique value of each of the CPUs and the CPU having no unique value are located in parallel.

### Fourth Embodiment

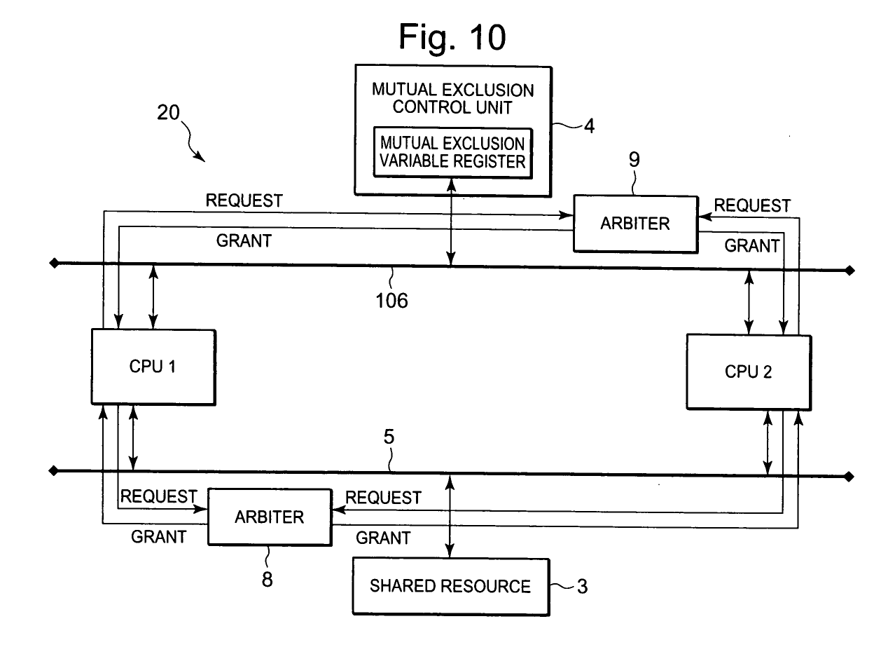

FIG. 10 is a block diagram showing the configuration of the multiprocessor system 20 according to a fourth embodiment of the present invention. In the above first to third embodiments, a description is given of the configuration in which the arbiter 41 is incorporated into the mutual exclusion control unit 4. On the other hand, in this embodiment, a local bus arbiter 9 is configured separately from the mutual exclusion control unit 4. In this case, the local buses 6 and 7 in each of the CPUs are not connected to the mutual exclusion control unit, respectively, but a local bus 106 for connection to the mutual exclusion control unit 4 is commonly formed. The arbiter 9 arbitrates the access request to the mutual exclusion control unit 4 from the plural CPUs, and permits the use of the local bus 106 with respect to any one of the CPUs.

The operation of the CPU that is permitted to use the local bus with respect to the mutual exclusion control register 42 is identical with that in the first embodiment, and therefore its detailed description will be omitted.

### Fifth Embodiment

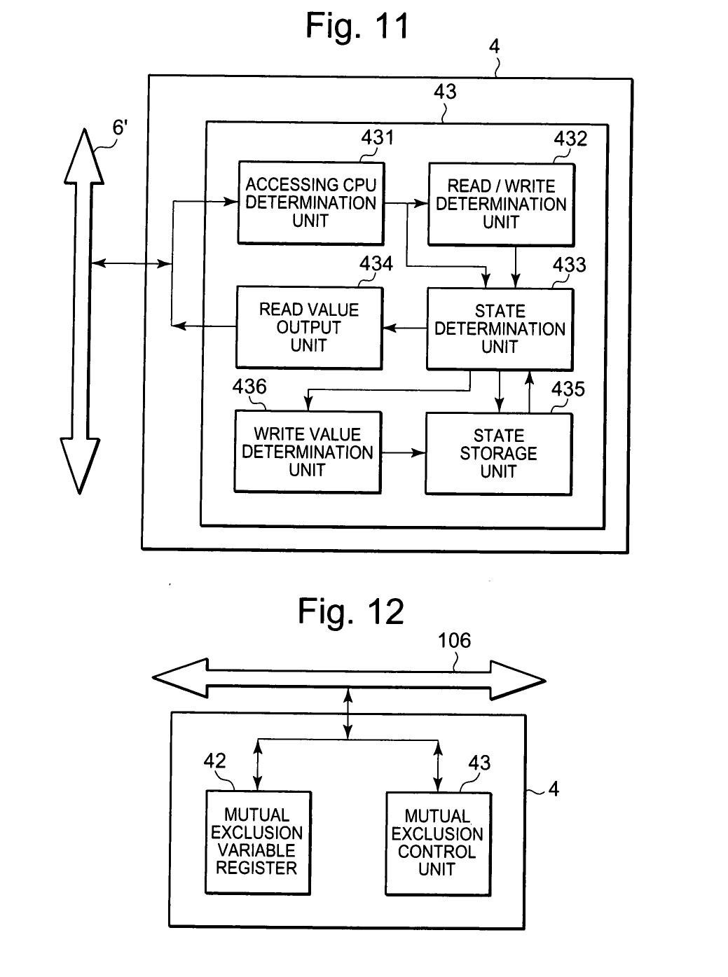

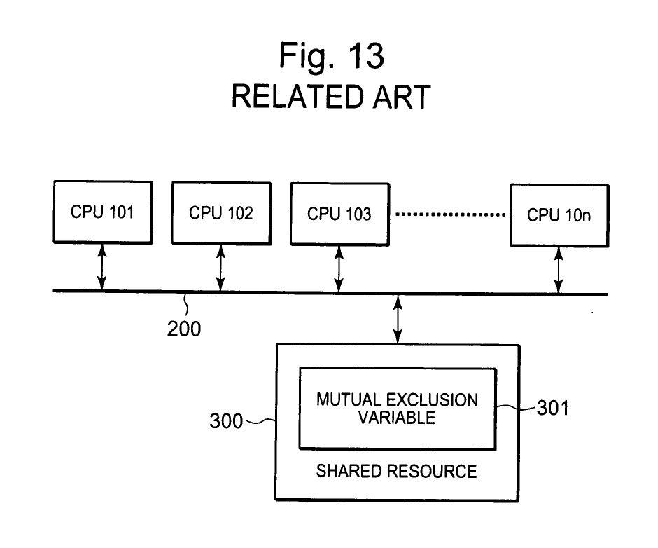

FIG. 11 is a diagram showing the configuration of the mutual exclusion control unit according to a fifth embodiment of the present invention. This embodiment corresponds to a case in which the mutual exclusion control unit 4 described in the second embodiment is applied to a case in which the local bus 106 described in the fourth embodiment is commonly formed. In this embodiment, it is possible to give information on the CPU that uses the local bus 106 to the accessing CPU determination unit 431 from the local bus arbiter 9. Alternatively, it is possible that the CPU that uses the local bus 106 transmits the read request through the local bus together with the identification information unique to the CPU, and the accessing CPU determination unit 431 determines the accessing CPU from the unique information.

The subsequent operation of the state determination or the state storage is identical with that in the second embodiment, and therefore its detailed description will be omitted.

### Sixth Embodiment

FIG. 12 is a block diagram showing the configuration of the mutual exclusion control unit 4 according to a sixth embodiment of the present invention. This embodiment corresponds to a case in which the mutual exclusion control unit 4 described in the third embodiment is applied to a case in which the local bus 106 described in the fourth embodiment is commonly formed. The detailed operation and configuration are identical with those in the first and second embodiments, and therefore will be omitted.

The present invention has been described in detail on the basis of the embodiments. However, the present invention is not limited to the above embodiment, but various changes may be made without departing from the scope of the invention. For example, in the above embodiments, one shared resource is used, but even in the case where plural shared resources are provided, the mutual exclusion variable registers and the mutual exclusion control units corresponding to the respective shared resources can be provided within one mutual exclusion control unit.

What is claimed is:

1. A multiprocessor system comprising:
a plurality of processors;
a shared resource capable of being accessed by the plurality of processors;
a shared bus coupled to the plurality of processors and the shared resource;
a mutual exclusion control unit holding identification information indicating which processor has an access right to the shared resource among the plurality of processors; and
a local bus coupled to the mutual exclusion control unit and the plurality of processors.

2. The multiprocessor system according to claim 1,
wherein the mutual exclusion control unit includes a register holding one of unique values associated respectively to the plurality of processors as the identification information.

3. The multiprocessor system according to claim 1,
wherein the mutual exclusion control unit comprises:
a state storage unit storing the identification information;
an accessing processor determination unit specifying a processor which is currently requesting an access right to the shared resource; and
a state determination unit providing the processor which is currently requesting an access right to the shared resource with information indicative of whether the access right is granted or not via the local bus in response to the identification information stored in the state storage unit.

4. The multiprocessor system according to claim 3,
wherein the state storage unit stores information indicating that none of the plurality of processors has the access right to the shared resource, or information indicating which processor has the access right to the shared resource among the plurality of processors.

5. The multiprocessor system according to claim 3,
wherein the mutual exclusion control unit outputs information indicating that the access right is newly acquired, information indicating that the access right has been already acquired, or information indicating that another processor has acquired the access right to the processor that requests the access right on the basis of an output of the state determination unit.

6. The multiprocessor system according to claim 3,
wherein the processor that has acquired the access right to the shared resource among the plurality of processors outputs any one of a write value indicating that the access right is released or maintained to the mutual exclusion control unit when releasing the access right.

7. The multiprocessor system according to claim 6,
wherein the information that is stored in the state storage unit is maintained or changed on the basis of the write value.

8. The multiprocessor system according to claim 3,
wherein the mutual exclusion control unit outputs a signal indicative of an access disenable to the processor that requests the access right to the shared resource in the case where the processor that requests the access right to the shared resource is different from the processor that holds the access right to the shared resource.

9. The multiprocessor system according to claim 1,
wherein the mutual exclusion control unit has a first arbiter that permits an access to the identification information through the local bus with respect to one of the plurality of processors.

10. The multiprocessor system according to claim 9, further comprising: a second arbiter that gives a use right of the shared bus to one of the plurality of processors upon receiving requests from the plurality of processors.

11. The multiprocessor system according to claim 1, further comprising: a first arbiter that gives a use right of the local bus to one of the plurality of processors upon receiving requests from the plurality of processors before accessing to the identification information through the local bus.

12. The multiprocessor system according to claim 11, further comprising: a second arbiter that gives a use right of the shared bus to one of the plurality of processors upon receiving requests from the plurality of processors.

13. The multiprocessor system according to claim 1,
wherein the local bus comprises a plurality of local buses so that the mutual exclusion control unit and the plurality of processors are connected one-on-one.

14. The multiprocessor system according to claim 1,
wherein the local bus is commonly connected to the plurality of processors.

15. An access right setting method of setting an access right to one of a plurality of processors with respect to a shared resource coupled to the plurality of processors via a shared bus, the method comprising:
holding identification information indicating which processor has an access right to the shared resource among the plurality of processors;
receiving a request to acquire an access right to the shared resource from one of the plurality of processors via a local bus;
determining a processor which is currently requesting an access right to the shared resource;
comparing the determination result with the identification information; and
providing the processor which is currently requesting an access right to the shared resource with information indicative of whether the access right is granted or not via the local bus.
